(19) United States
(12) Patent Application Publication
(10) Pub. No.: US 2005/0068083 A1
(43) Pub. Date: Mar. 31, 2005

(54) Clock input circuit of microcomputer that can remove noise at high accuracy

(75) Inventor: Michiaki Kuroiwa, Hyogo (JP)

Correspondence Address: McDermott, Will & Emery LLP, 600 13th Street, N.W., Washington, DC, 20005-3096, US

(73) Assignee: RENESAS TECHNOLOGY CORP

(21) Appl. No.: 10/944,904

(22) Filed: Sep. 21, 2004

(30) Foreign Application Priority Data
Sep. 26, 2003 (JP) 2003-335186(P)

(51) Int. Cl. G06F 1/04

(52) U.S. Cl. 327/291

(57) ABSTRACT

A clock input circuit includes a switch circuit, a switching circuit, and a programmable register to provide switching control based on the level of a power supply voltage of a microcomputer. When the power supply voltage of the microcomputer is equal to or higher than a predetermined value, general noise removal is conducted through two Schmitt trigger circuit and a capacitor. When the power supply voltage of the microcomputer is lower than the predetermined value, noise removal is conducted through a Schmitt trigger circuit, and two flip-flops. Thus, noise removal of high accuracy can be realized, independent of the power supply voltage of the microcomputer.

### BACKGROUND OF THE INVENTION

1. Field of the Invention

The present invention relates to clock input circuits, and particularly, a clock input circuit of a microcomputer.

2. Description of the Background Art

A clock input circuit of a microcomputer receives an externally applied reference clock signal to generate a system clock signal that defines the operation of the microcomputer.

A conventional clock input circuit of a microcomputer includes a low pass filter that cuts the high frequency component of a reference clock signal, and a clock generation circuit receiving an output signal of the low pass filter to generate a system clock signal. When the power supply voltage of the microcomputer is reduced, the cut off frequency of the low pass filter in the clock input circuit will become lower so that even the necessary frequency components are cut off. However, if this low pass filter is not used, noise of high frequency, when introduced into the reference clock signal, will cause erroneous operation of the system.

A conventional pulse generation circuit of a microcomputer is proposed, including a frequency divider dividing a clock signal output from an oscillator, shaped in waveform, and a select circuit that selects and outputs arbitrarily one of an input signal and an output signal of the frequency divider. A noise removal circuit is provided at the succeeding stage of the select circuit. The select circuit selects the input signal of the frequency divider when the operating power supply voltage is high enough, and selects the output signal of the frequency divider when the operating power supply voltage is low. Accordingly, a pulse generation circuit impervious to noise with respect to an operating power supply voltage of a wide range can be realized (for example, Japanese Patent Laying-Open No. 11-008536).

A clock generation circuit generating a clock signal and impervious to noise is also proposed. This clock generation circuit includes a frequency divider dividing an externally applied reference clock signal, and an edge timing modify circuit modifying the edge timing of the output signal from the frequency divider. In this case, the erroneous operation of a digital circuit operating in synchronization with the clock signal can be reduced (for example, Japanese Patent Laying-Open No. 2003-015761).

Furthermore, a data extraction circuit is proposed, including an up-down counter that counts a predetermined clock to integrate input data. The circuit will become more impervious to noise, suppressing erroneous operation of data identification with respect to transmitted data (for example, Japanese Patent Laying-Open No. 63-014544).

Thus, the conventional clock input circuit of a microcomputer had the problem that the accuracy of noise removal is reduced depending upon the power supply voltage of the microcomputer.

### SUMMARY OF THE INVENTION

In view of the foregoing, a main object of the present invention is to provide a clock input circuit that can have noise removed in high accuracy, independent of the power supply voltage of a microcomputer.

According to an aspect of the present invention, a clock input circuit includes a noise removal circuit. The noise removal circuit includes a first waveform shaping circuit receiving an externally applied reference clock signal, a capacitor receiving a clock signal from the first waveform shaping circuit at one electrode and receiving a reference potential at its other electrode, and a second waveform shaping circuit shaping the waveform of a clock signal appearing at one electrode of the capacitor. The clock input circuit also includes a frequency divider circuit frequency-dividing a clock signal from the first waveform shaping circuit, a switch circuit selecting the noise removal circuit in response to a first control signal indicating that the power supply voltage of a microcomputer is higher than a predetermined value, and selecting the frequency divider circuit in response to a second control signal indicating that the power supply voltage of the microcomputer is lower than the predetermined value, and a clock generation circuit generating a system clock signal to operate the microcomputer based on an output signal from the circuit selected by the switch circuit. When the power supply voltage of the microcomputer is higher than the predetermined value, general noise removal is conducted through the noise removal circuit. When the power supply voltage of the microcomputer is lower than the predetermined value, noise removal is conducted through the frequency divider circuit. Therefore, noise can be removed at high accuracy even when the power supply voltage of the microcomputer becomes lower.

According to another aspect of the present invention, a clock input circuit includes a first waveform shaping circuit receiving an externally applied reference clock signal, a first capacitor receiving a clock signal from the first waveform shaping circuit at one electrode and receiving a reference potential at its other electrode, a second capacitor receiving the reference potential at one electrode, a switching element connecting an output node of the first waveform shaping circuit with an other electrode of the second capacitor in response to a first control signal indicating that a power supply voltage of a microcomputer is higher than a predetermined value, and disconnecting the output node of the first waveform shaping circuit from the other electrode of the second capacitor in response to a second control signal indicating that the power supply voltage of the microcomputer is lower than the predetermined value, a second waveform shaping circuit shaping the waveform of a clock signal appearing at the one electrode of the first capacitor, and a clock generation circuit generating a system clock signal to operate the microcomputer based on the output signal of the second waveform shaping circuit. Since the cut off frequency of a low pass filter will not become lower than a predetermined frequency even if the power supply voltage of the microcomputer becomes lower than a predetermined value, removal of necessary frequency component of an externally applied reference clock signal can be suppressed. Therefore, noise removal of high accuracy, independent of the power supply voltage of the microcomputer can be realized.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram of a schematic configuration of a clock input circuit according to a first embodiment of the present invention.

FIG. 2 is a circuit diagram of a configuration of the clock generation circuit in FIG. 1.

FIG. 3 is a timing chart representing an operation of a clock input circuit when noise is not introduced into a reference clock signal CLK0.

FIG. 4 is a timing chart representing an operation of a clock input circuit when noise is introduced into reference clock signal CLK0.

FIG. 5 is a block diagram of a schematic configuration of a clock input circuit according to a modification of the first embodiment.

FIG. 6 is a block diagram of a schematic configuration of a clock input circuit according to another modification of the first embodiment.

FIG. 7 is a block diagram of a schematic configuration of a clock input circuit according to a second embodiment of the present invention.

FIG. 8 is a block diagram of a schematic configuration of a clock input circuit according to a modification of the second embodiment.

FIG. 9 is a block diagram of a schematic configuration of a clock input circuit according to a third embodiment of the present invention.

FIG. 10 is a circuit diagram of a configuration of a clock generation circuit in FIG. 9.

FIG. 11 is a block diagram of a schematic configuration of a clock input circuit according to a fourth embodiment of the present invention.

### DESCRIPTION OF THE PREFERRED EMBODIMENTS

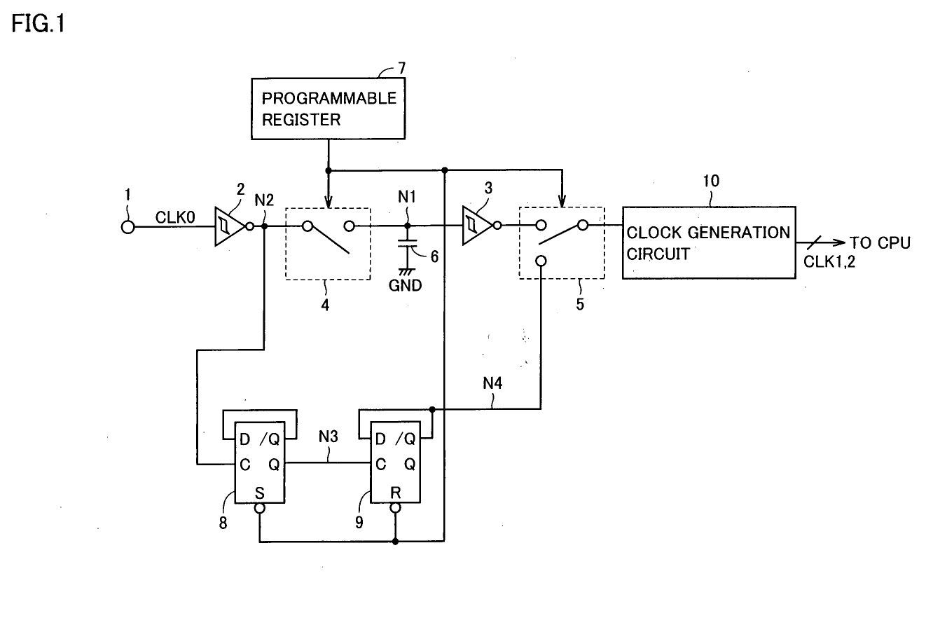

Referring to FIG. 1, a clock input circuit according to a first embodiment of the present invention includes an input terminal 1, Schmitt trigger circuits 2 and 3, a switch circuit 4, a switching circuit 5, a capacitor 6, a programmable register 7, flip-flops 8 and 9, and a clock generation circuit 10.

Schmitt trigger circuit 2 and switch circuit 4 are connected in series between input terminal 1 and a node N1. Capacitor 6 is connected between node N1 and a ground potential GND line. Schmitt trigger circuit 3 and switching circuit 5 are connected in series between node N1 and clock generation circuit 10. Flip-flop 8 has its clock input terminal C connected to an output node N2 of Schmitt trigger circuit 2, and has its negative logic output terminal /Q connected to a data input terminal D. Flip-flop 9 has its clock input terminal C connected to a positive logic output terminal Q of flip-flop 8, and has its negative logic output terminal /Q connected to data input terminal D, and also to switching circuit 5. Flip-flops 8 and 9 respectively form a frequency divider circuit. The output signal of programmable register 7 is provided to switch circuit 4, switching circuit 5, a set input terminal S of flip-flop 8, and a reset input terminal R of flip-flop 9.

Schmitt trigger circuit 2 receives an externally applied reference clock signal CLK0 via input terminal 1 to shape the waveform of reference clock signal CLK0. The waveform-shaped reference clock signal is provided to switch circuit 4 and flip-flop 8. The set data of programmable register 7 is set to 0 when the power supply voltage of the microcomputer is equal to or higher than a predetermined value, and to 1 when the power supply voltage of the microcomputer is lower than the predetermined value. Programmable register 7 outputs a control signal of an L level and an H level when the set data is 0 and 1, respectively.

Switch circuit 4 connects Schmitt trigger circuit 2 with node N1 when the control signal from programmable register 7 is at an L level, and disconnects Schmitt trigger circuit 2 from node N1 when the control signal from programmable register 7 is at an H level. In other words, when the control signal from programmable register 7 is at an L level, the output resistance of Schmitt trigger circuit 2 and capacitor 6 constitute a low pass filter (RC integrating circuit) to cut the high frequency component of the input signal to remove noise of high frequency. Schmitt trigger circuit 3 shapes the waveform of the output signal from the low pass filter.

Switching circuit 5 connects Schmitt trigger circuit 3 with clock generation circuit 10 when the control signal from programmable register 7 is at an L level, and connects flip-flop 9 with clock generation circuit 10 when the control signal from programmable register 7 is at an H level.

Thus, when the power supply voltage of the microcomputer is equal to or above a predetermined value, general noise removal is conducted through Schmitt trigger circuits 2 and 3 and capacitor 6. When the power supply voltage of the microcomputer is lower than the predetermined value, noise removal is conducted through Schmitt trigger circuit 2 and flip-flops 8 and 9.

Flip-flop 8 is rendered inactive when the control signal from programmable register 7 is at an L level to output a signal of an H level from positive logic output terminal Q. When the control signal from programmable register 7 is at an H level, flip-flop 8 is rendered active, and the clock signal from Schmitt trigger circuit 2 is divided by a factor of 2 (frequency-divided to ½). In other words, the logic level of the output signal is inverted in response to the rising edge of the clock signal applied to clock input terminal C. Flip-flop 9 is rendered inactive when the control signal from programmable register 7 is at an L level to output a signal of an H level from negative logic output terminal Q. When the control signal from programmable register 7 is at an H level, flip-flop 9 is rendered active, and the clock signal from positive logic output terminal Q of flip-flop 8 is divided by a factor of 2 (frequency-divided to ½). In other words, the logic level of the output signal is inverted in response to the rising edge of the clock signal applied to clock input terminal C.

Clock generation circuit 10 receives a clock signal from Schmitt trigger circuit 3 or flip-flop 9 via switching circuit 5 to generate and provide to a CPU (Central Processing Unit) system clock signals CLK1 and CLK2 complementary to each other.

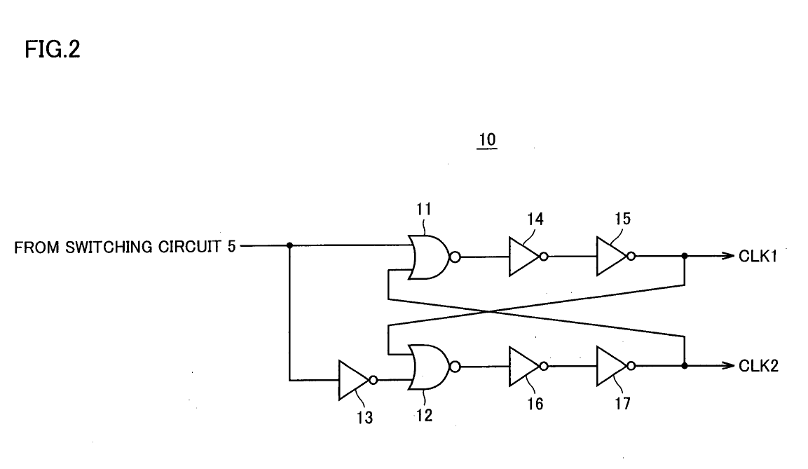

Referring to FIG. 2, clock generation circuit 10 includes NOR circuits 11 and 12, and inverters 13-17.

NOR circuit 11 receives a clock signal from switching circuit 5 at one input terminal, and receives the output signal of inverter 17 at its other input terminal. NOR circuit 12 receives the clock signal from switching circuit 5 via inverter 13 at one input terminal, and receives the output signal of inverter 15 at its other input terminal. Inverter 15 receives the output signal of NOR circuit 11 via inverter 14 to output system clock signal CLK1. Inverter 17 receives the output signal from NOR circuit 12 via inverter 16 to output system clock signal CLK2.

When the clock signal from switching circuit 5 is at an L level, inverter 13 provides an output signal of an H level, so that the output signal of NOR circuit 12 attains an L level. In response, system clock signal CLK2 from inverter 17 attains an L level. Since NOR circuit 11 provides an output signal of an H level at this stage, system clock signal CLK1 from inverter 15 attains an H level.

When the clock signal from switching circuit 5 is at an H level, NOR circuit 11 provides an output signal of an L level. In response, system clock signal CLK1 from inverter 15 attains an L level. Since NOR circuit 12 provides an output signal of an H level at this stage, system clock signal CLK2 from inverter 17 attains an H level.

Thus, clock generation circuit 10 generates complementary system clock signals CLK1 and CLK2 based on the clock signal from switching circuit 5. Although not shown, a frequency divider circuit may be provided between switching circuit 5 and clock generation circuit 10. In this case, the frequency divider circuit frequency-divides the input clock signal to clock generation circuit 10. Therefore, clock generation circuit 10 generates system clock signals CLK1 and CLK2 of lower frequency.

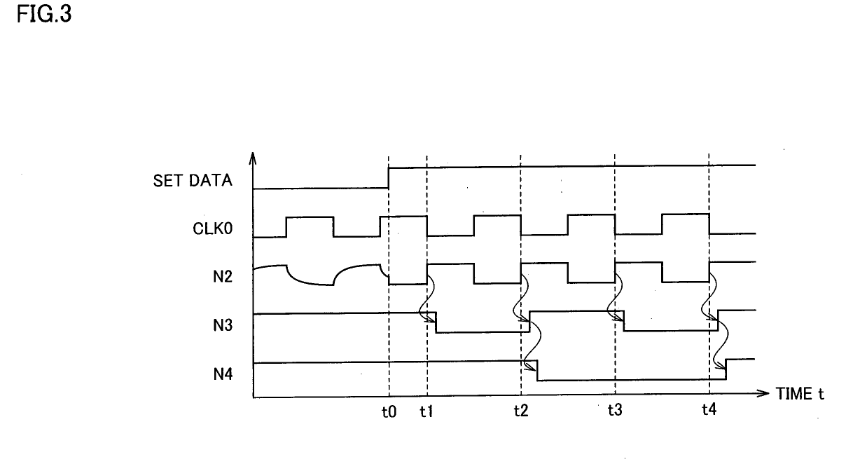

The operation of the clock input circuit will be described with reference to the timing chart of FIG. 3. Referring to FIG. 3, the set data of programmable register 7 is switched from 0 to 1 in response to the power supply voltage of the microcomputer becoming lower than a predetermined value at time t0.

The set data of programmable register 7 is 0 before time t0. Programmable register 7 provides a control signal of an L level to switch circuit 4, switching circuit 5, and flip-flops 8 and 9 based on the set data of 0. Switch circuit 4 connects Schmitt trigger circuit 2 with node N1 in response to the control signal of an L level from programmable register 7. Switching circuit 5 connects Schmitt trigger circuit 3 with clock generation circuit 10 in response to a control signal of an L level from programmable register 7. The signal at output node N2 of Schmitt trigger circuit 2 has a waveform that is a logic-inverted version of reference clock signal CLK0 by Schmitt trigger circuit 2. At this stage, the signal transmitted at output node N2 takes a rounded waveform by capacitor 6. Further, flip-flops 8 and 9 hold the potentials of nodes N3 and N4 at the H level according to the control signal of an L level from programmable register 7. As used herein, node N3 is a node between flip-flop 8 and flip-flop 9, and node N4 is a node between flip-flop 9 and switching circuit 5.

At time t0, the set data of programmable register 7 is switched to 1. Programmable register 7 pulls up the control signal to switch circuit 4, switching circuit 5 and flip-flops 8 and 9 to an H level. In response, switch circuit 4 disconnects Schmitt trigger circuit 2 from node N1, and switching circuit 5 connects flip-flop 9 with clock generation circuit 10.

From time t0 onwards, the waveform of the signal transmitted through output node N2 is not rounded since output node N2 is impervious to capacitor 6. Flip-flop 8 responds to the control signal of programmable register 7 being pulled up to an H level to divide the clock signal from output node N2 by a factor of 2 (frequency-divided to ½). The frequency-divided signal is provided to node N3. Flip-flop 9 responds to the control signal of programmable register 7 being pulled up to an H level to divide the clock signal from node N3 by a factor of 2 (frequency-divided to ½). The frequency-divided signal is provided to node N4.

In response to reference clock signal CLK0 pulled down to an L level at time t1, the potential of output node N2 is pulled up to an H level. In response, the potential of node N3 is pulled down to an L level.

In response to reference clock signal CLK0 pull down to an L level at time t2, the potential of output node N2 is pulled up to an H level. In response, the potential at node N3 is pulled up to an H level, and the potential of node N4 is pulled down to an L level. In response to reference clock signal CLK0 pulled down to an L level at time t3, the potential of output node N2 is pulled up to an H level. In response, the potential of node N3 is pulled down to an L level.

In response to reference clock signal CLK0 pull down to an L level at time t4, the potential of output node N2 is pulled up to an H level. In response, the potential of node N3 is pulled up to an H level, and the potential of node N4 is pulled up to an H level. Thus, the clock signal from Schmitt trigger circuit 2 is divided by a factor of 4 by flip-flops 8 and 9 (frequency-divided to ¼), and provided to clock generation circuit 10.

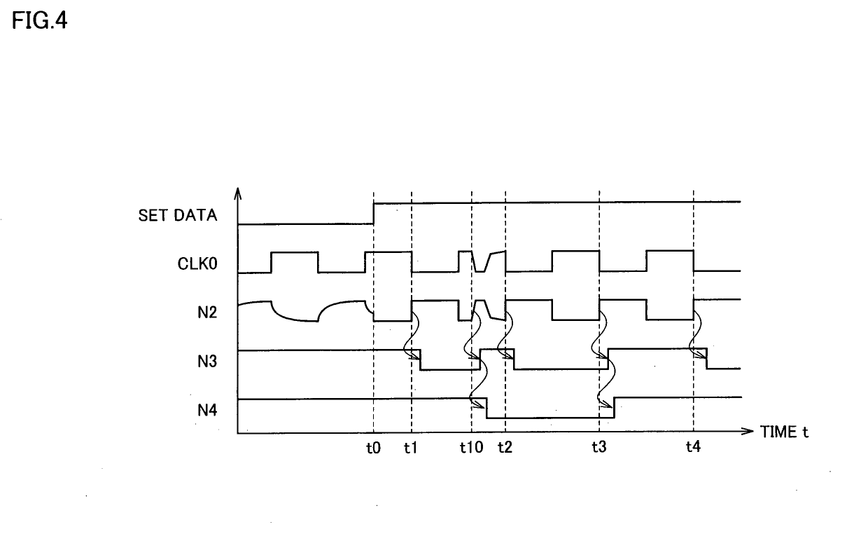

Referring to FIG. 4 corresponding to the case where noise is introduced into reference clock signal CLK0, the set data of programmable register 7 is switched from 0 to 1 in response to the power supply voltage of the microcomputer becoming lower than the predetermined value at time t0.

The signal waveform until time t1 is identical to that of FIG. 3. At time t10 between time t1 and time t2, a spike noise of a short pulse width is introduced into reference clock signal CLK0. The spike noise introduced into reference clock signal CLK0 is transmitted to output node N2. In response to the rising edge of the spike noise at node N2, the potential of node N3 is pulled up to an H level. Accordingly, the potential of node N4 is pulled down to an L level.

In response to reference clock signal CLK0 pulled down to an L level at time t2, the potential of output node N2 is pulled up to an H level. Accordingly, the potential of node N3 is pulled down to an L level.

In response to reference clock signal CLK0 pulled down to an L level at time t3, the potential of output node N2 is pulled up to an H level. Accordingly, the potential of node N3 is pulled up to an H level, and the potential of node N4 is pulled up to an H level.

In response to reference clock signal CLK0 pulled down to an L level at time t4, the potential of output node N2 is pulled up to an H level. Accordingly, the potential of node N3 is pulled down to an L level.

When a spike noise is introduced into reference clock signal CLK0, the signal transmitted through node N4 takes a waveform that is ahead in phase by just one cycle of reference clock signal CLK0, as compared to the case where a spike noise is not introduced (refer to FIG. 3). Thus, even in the case where noise of a short pulse width is introduced into reference clock signal CLK0, the waveform of the noise is frequency-divided by flip-flops 8 and 9, so that a clock signal of a short pulse width will not be transmitted to node N4. Although the frequency of system clock signals CLK1 and CLK2 generated by clock generation circuit 10 becomes lower so that the processing rate of the CPU is reduced at this stage, erroneous operation of the system will not occur.

A conventional clock input circuit of a microcomputer is absent of flip-flops 8 and 9. If the power supply voltage of the microcomputer is reduced, the voltage supplied to Schmitt trigger circuit 2 will also be reduced. Therefore, the drivability of the transistor constituting Schmitt trigger circuit 2 is reduced, so that the output resistance of Schmitt trigger circuit 2 is increased. Accordingly, the CR time constant of the low pass filter (RC integrating circuit) formed of the output resistance of Schmitt trigger circuit 2 and capacitor 6 is increased. Therefore, the cut off frequency of the low pass filter is reduced, so that the required frequency component of externally applied reference clock signal CLK0 may be removed.

In the present first embodiment, flip-flops 8 and 9 are provided. When the power supply voltage of the microcomputer is equal to or higher than a predetermined value, general noise removal is conducted through Schmitt trigger circuits 2 and 3 and capacitor 6 by setting the set data of programmable register 7 to 0. When the power supply voltage of the microcomputer is lower than the predetermined value, noise removal is conducted through Schmitt trigger circuit 2 and flip-flops 8 and 9 by setting the set data of programmable register 7 to 1. Thus, noise removal of high accuracy can be realized, independent of the power supply voltage of the microcomputer.

### Modification of First Embodiment

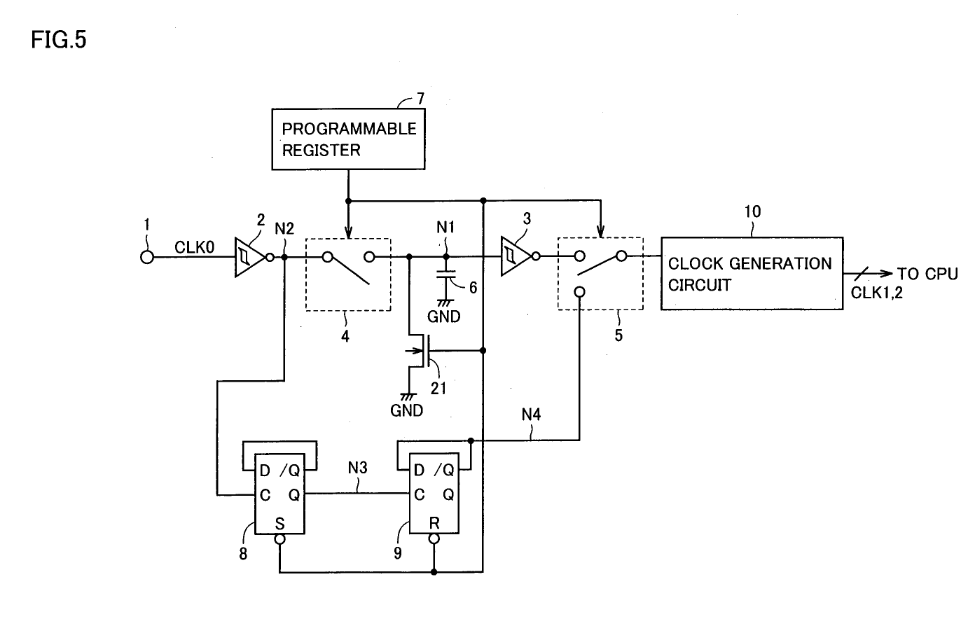

FIG. 5 represents a clock input circuit according to a modification of the first embodiment. The clock input circuit of FIG. 5 differs from the clock input circuit of FIG. 1 in that an N channel MOS transistor 21 is added.

N channel MOS transistor 21 is connected between node N1 and the line of ground potential GND, and receives a control signal from programmable register 7 at its gate. N channel MOS transistor 21 is rendered non-conductive and conductive when the control signal from programmable register 7 is at an L level and an H level, respectively.

When the set data of programmable register 7 is 1, switch circuit 4 receives a control signal of an H level from programmable register 7 to disconnect Schmitt trigger circuit 2 from node N1. If N channel MOS transistor 21 is not provided, the potential of the input signal of Schmitt trigger circuit 3 will become indefinite. Unnecessary through current will flow across Schmitt trigger circuit 3 to increase power consumption of the microcomputer.

Provision of N channel MOS transistor 21 in the modification of the first embodiment allows the potential of the input signal of Schmitt trigger circuit 3 to be fixed at the level of ground potential GND when the set data of programmable register 7 is 1. This prevents unnecessary through current from flowing across Schmitt trigger circuit 3. Thus, power consumption of the microcomputer is reduced.

### Another Modification of First Embodiment

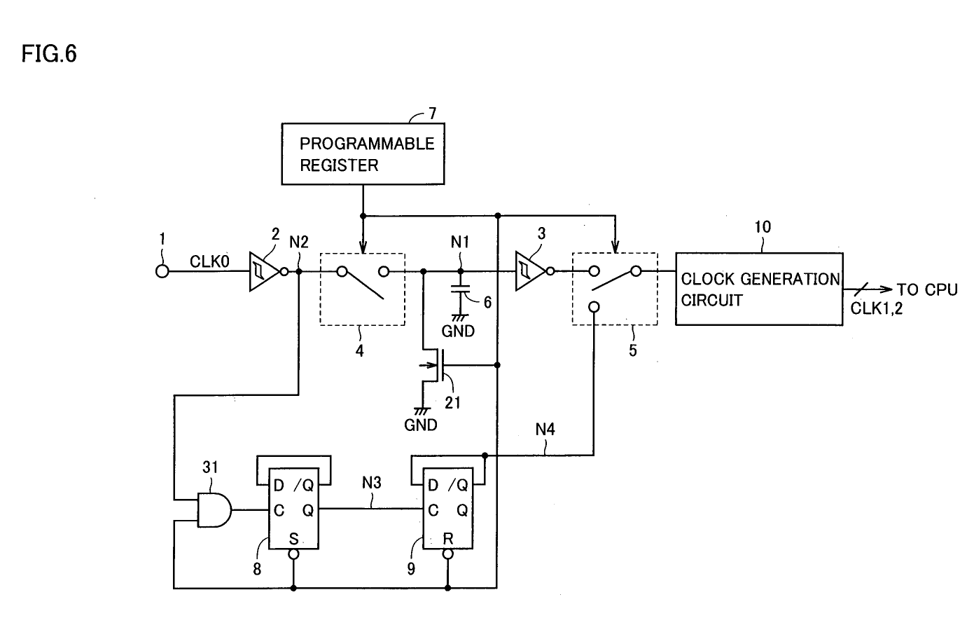

FIG. 6 represents a clock input circuit according to another modification of the first embodiment. The clock input circuit of FIG. 6 differs from the clock input circuit of FIG. 5 corresponding to a modification of the first embodiment in that an AND circuit 31 is added.

AND circuit 31 has one input terminal connected to output node N2 of Schmitt trigger circuit 2, receives a control signal from programmable register 7 at its other input terminal, and has its output terminal connected to clock input terminal C of flip-flop 8.

When the set data of programmable register 7 is 0, flip-flops 8 and 9 are not used. If AND circuit 31 is not provided, the clock input terminal of flip-flop 8 will receive the clock signal from Schmitt trigger circuit 2, whereby unnecessary operating current will flow to flip-flops 8 and 9.

The provision of AND circuit 31 in the another modification of the first embodiment allows the potential of the clock input terminal of flip-flop 8 to be fixed at the L level when the set data of programmable register 7 is 0. Accordingly, a flow of unnecessary operating current to flip-flops 8 and 9 is suppressed.

### Second Embodiment

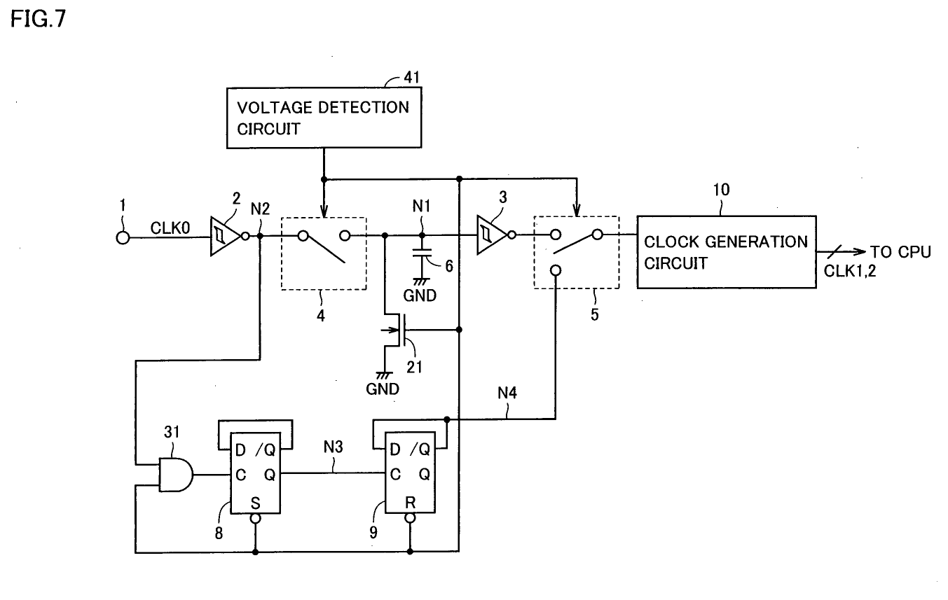

FIG. 7 represents a clock input circuit according to a second embodiment. The clock input circuit of FIG. 7 differs from the clock input circuit of FIG. 6 corresponding to another modification of the first embodiment in that a voltage detection circuit 41 is provided instead of programmable register 7.

Voltage detection circuit 41 detects the power supply voltage of the microcomputer to output a control signal of an L level when the power supply voltage of the microcomputer is equal to or higher than a predetermined value, and outputs a control signal of an H level when the power supply voltage of the microcomputer is lower than the predetermined value. The control signal from voltage detection circuit 41 is provided to switch circuit 4, switching circuit 5, N channel MOS transistor 21, set input terminal S of flip-flop 8, reset input terminal R of flip-flop 9, and the input terminal of AND circuit 31.

When the control signal from voltage detection circuit 41 is at an L level, general noise removal is conducted through Schmitt trigger circuits 2 and 3 and capacitor 6. When the control signal from voltage detection circuit 41 is at an H level, noise removal is conducted through Schmitt trigger circuit 2 and flip-flops 8 and 9.

In the case where general noise removal is conducted through Schmitt trigger circuits 2 and 3 and capacitor 6, the power supply voltage of the microcomputer is high enough, and the necessary frequency component of externally applied reference clock signal CLK0 will not be removed.

In the case where programmable register 7 is employed as in the first embodiment, the level of the power supply voltage of the microcomputer must be monitored to alter the set data of programmable register 7 in accordance with the level of the power supply voltage of the microcomputer. The second embodiment is advantageous in that the logic level of the control signal from voltage detection circuit 41 is switched automatically in accordance with the level of the power supply voltage of the microcomputer to eliminate further load.

### Modification of Second Embodiment

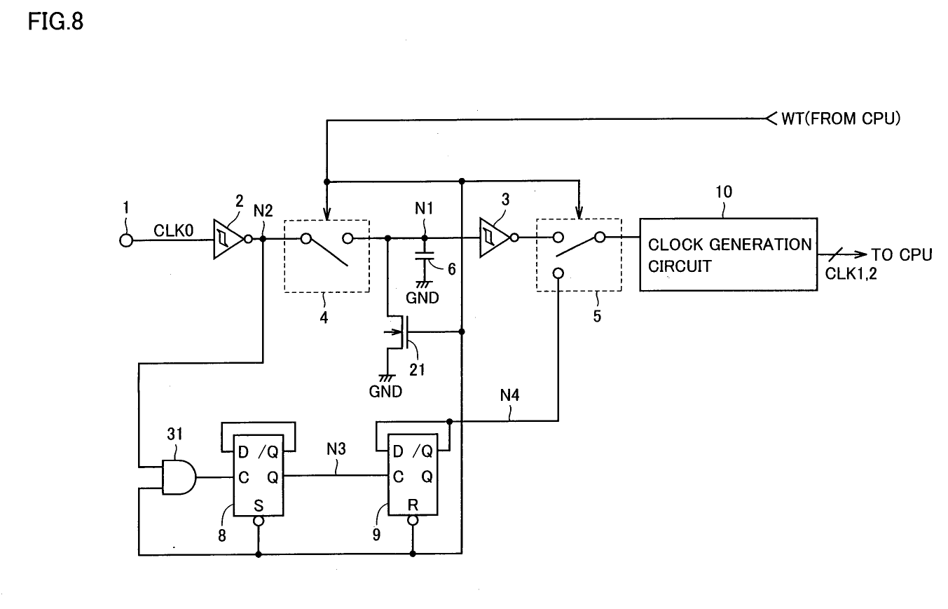

FIG. 8 represents a clock input circuit according to a modification of the second embodiment. The clock input circuit of FIG. 8 differs from the previous clock input circuit of FIG. 7 in that voltage detection circuit 41 is removed, and a wait signal WT from the CPU is employed as an alternative to the control signal from voltage detection circuit 41.

The CPU drives wait signal WT to an activation level of H when in a wait status such as standing by for an available resource that is required (for example, input/output apparatus), or waiting for arrival of a message. In a normal operation mode, wait signal WT is set at an inactivation level of L. Wait signal WT is triggered by an external control signal, or an overflow signal from an internal timer in the CPU (a signal rendered active when the timer counts over a predetermined time) to have its logic level switched.

When wait signal WT from the CPU is at an L level, general noise removal is conducted through Schmitt trigger circuits 2 and 3 and capacitor 6. When wait signal WT is at an H level, noise removal is conducted through Schmitt trigger circuit 2 and flip-flops 8 and 9.

In this context, the present modification takes advantage of the fact that, when the CPU is in a wait state (wait signal WT is at an H level), the power supply voltage of the microcomputer is low, whereas the power supply voltage of the microcomputer is sufficiently high in a normal operation mode (wait signal WT is at an L level).

By using a wait signal WT from the CPU in the present modification of the second embodiment, noise removal can be conducted appropriately in accordance with the level of the power supply voltage of the microcomputer.

### Third Embodiment

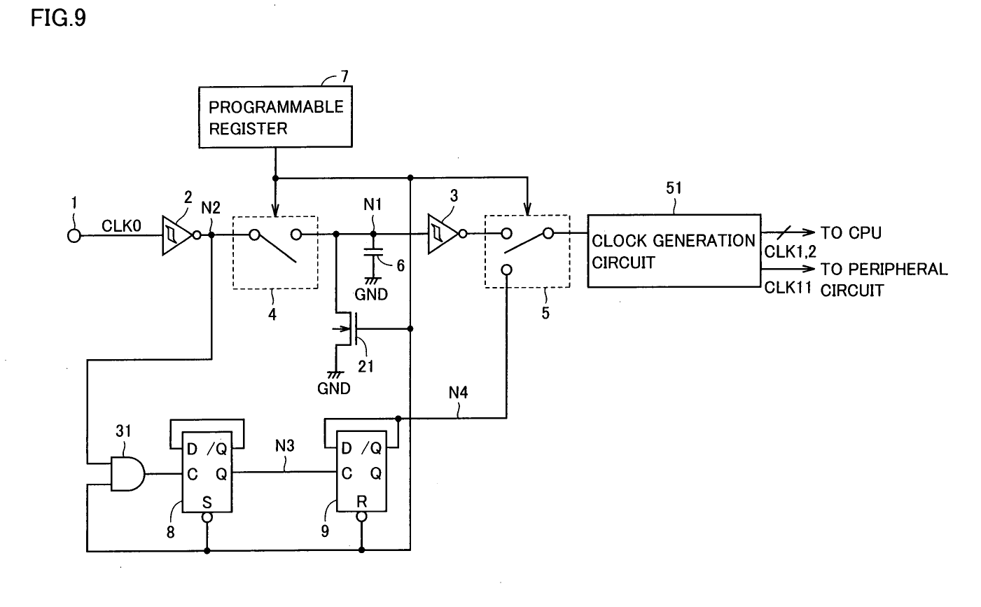

FIG. 9 represents a clock input circuit according to a third embodiment. The clock input circuit of FIG. 9 differs from the clock input circuit of FIG. 6 corresponding to another modification of the first embodiment in that a clock generation circuit 51 is provided instead of clock generation circuit 10.

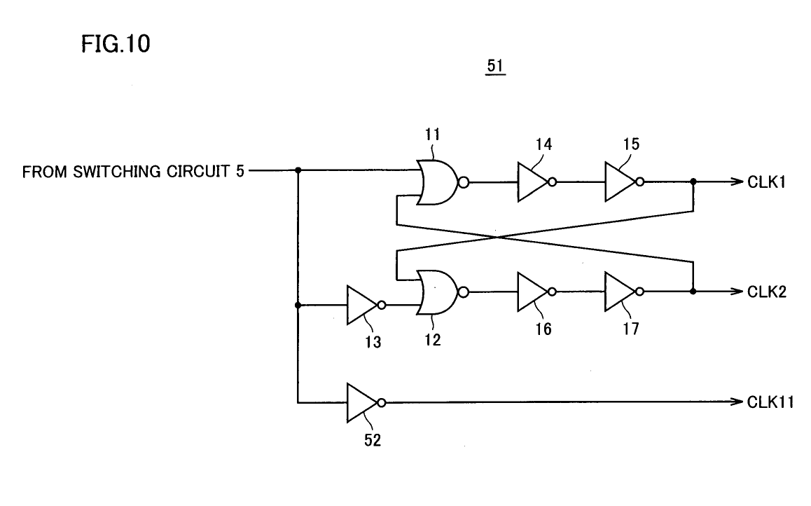

It is noted that clock generation circuit 51 of FIG. 10 differs from clock generation circuit 10 of FIG. 2 in that an inverter 52 is added.

Referring to FIG. 10, inverter 52 receives a clock signal from switching circuit 5 to output a clock signal CLK11 for a peripheral circuit. Clock signal CLK11 directed to the peripheral circuit differs in phase and amplitude from system clock signals CLK1 and CLK2 directed to the CPU. Peripheral circuit clock signal CLK11 is supplied to an A/D (Analog to Digital) converter, a timer, a serial input/output circuit, and the like. Accordingly, when the power supply voltage of the microcomputer is low so that noise removal is conducted through Schmitt trigger circuit 2 and flip-flops 8 and 9, the frequencies of CPU system clock signals CLK1 and CLK2 and peripheral circuit clock signal CLK11 are reduced in common.

As described in the first and second embodiments, when clock generation circuit 10 does not generate peripheral circuit clock signal CLK11, reduction in the power supply voltage of the microcomputer will cause the frequency of system clock signals CLK1 and CLK2 supplied to the CPU to be reduced by flip-flops 8 and 9. However, the frequency of clock signal CLK11 supplied to the peripheral circuit will not be reduced. In this case, there is a possibility of erroneous operation in the system.

In the present third embodiment, CPU system clock signals CLK1 and CLK2 and peripheral circuit clock signal CLK11 are controlled in common to prevent erroneous operation of the system.

Although the above embodiment was described in which only one inverter 52 to generate peripheral circuit clock signal CLK11 is provided, the number of inverters is arbitrary. For example, a plurality of inverters may be provided in series or in parallel. In the case where a plurality of inverters are provided in parallel to generate a plurality of clock signals for the peripheral circuit, different clock signals can be supplied to a plurality of peripheral circuits that require different clock signals.

### Fourth Embodiment

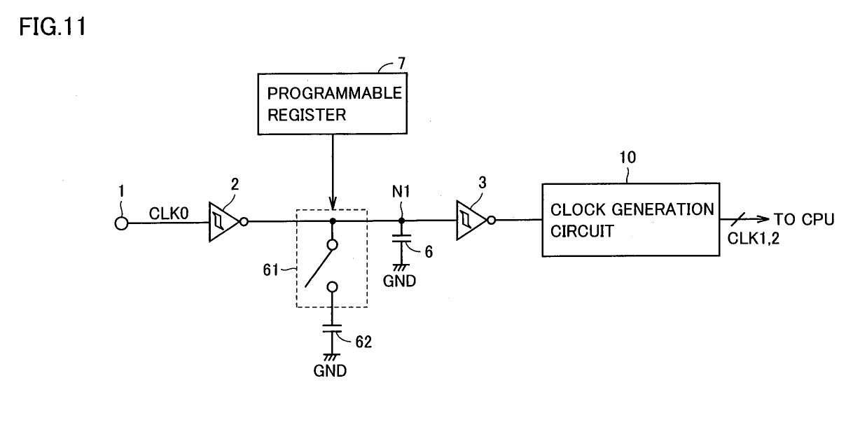

FIG. 11 represents a clock input circuit according to a fourth embodiment. The clock input circuit of FIG. 11 differs from the clock input circuit of FIG. 1 corresponding to the first embodiment in that switch circuit 4, switching circuit 5, and flip-flops 8 and 9 are removed, and a switch circuit 61 and a capacitor 62 are added.

Switch circuit 61 connects node N1 with capacitor 62 when the control signal from programmable register 7 is at an L level, and disconnects node N1 from capacitor 62 when the control signal from programmable register 7 is at an H level. In other words, when the control signal from programmable register 7 is at an L level, the output resistance of Schmitt trigger circuit 2 and capacitors 6 and 62 constitute a low pass filter (RC integrating circuit). When the control signal from programmable register 7 is at an H level, the output resistance of Schmitt trigger circuit 2 and capacitor 6 constitute a low pass filter (RC integrating circuit).

A conventional clock input circuit of the microcomputer is absent of switch circuit 61 and capacitor 62. When the power supply voltage of the microcomputer is reduced, the voltage applied to Schmitt trigger circuit 2 is also reduced. Therefore, the drivability of the transistor forming Schmitt trigger circuit 2 is reduced so that the output resistance of Schmitt trigger circuit 2 is increased. Accordingly, the CR time constant of the low pass filter (RC integrating circuit) formed of the output resistance of Schmitt trigger circuit 2 and capacitor 6 becomes larger. Therefore, the cut off frequency of the low pass filter will be reduced, inducing the possibility of the required frequency component of the externally applied reference clock signal CLK0 being removed.

In the present fourth embodiment, switch circuit 61 and capacitor 62 are provided. When the power supply voltage of the microcomputer is equal to or higher than a predetermined value, noise removal is conducted through Schmitt trigger circuits 2 and 3 and capacitors 6 and 62 by setting the set data of programmable register 7 to 0. When the power supply voltage of the microcomputer is lower than the predetermined value, noise removal is conducted through Schmitt trigger circuits 2 and 3 and capacitor 6 by setting the set data of programmable register 7 to 1. Therefore, although the output resistance of Schmitt trigger circuit 2 is increased when the power supply voltage of the microcomputer becomes lower than the predetermined value, the CR time constant of the low pass filter (RC integrating circuit) is reduced by disconnecting node N1 from capacitor 62 by means of switch circuit 61. Therefore, the cut off frequency of the low pass filter will not become lower than the predetermined frequency even if the power supply voltage of the microcomputer becomes lower than the predetermined value. Therefore, removal of the required frequency component of reference clock signal CLK0 is suppressed. Thus, noise removal of high accuracy can be realized, independent of the power supply voltage of the microcomputer.

The above embodiment was described in which switch circuit 61 is controlled by means of programmable register 7. As an alternative to programmable register 7, voltage detection circuit 41 of FIG. 7, or wait signal WT of FIG. 8 may be employed instead.

Although the present invention has been described and illustrated in detail, it is clearly understood that the same is by way of illustration and example only and is not to be taken by way of limitation, the spirit and scope of the present invention being limited only by the terms of the appended claims.

1. A clock input circuit of a microcomputer comprising:
a noise removal circuit including a first waveform shaping circuit receiving an externally applied reference clock signal, a capacitor receiving a clock signal from said first waveform shaping circuit at one electrode, and receiving a reference potential at its other electrode, and a second waveform shaping circuit shaping a waveform of a clock signal appearing at one electrode of said capacitor,
a frequency divider circuit frequency-dividing a clock signal from said first waveform shaping circuit,
a switching circuit selecting said noise removal circuit in response to a first control signal indicating that a power supply voltage of said microcomputer is higher than a predetermined value, and selecting said frequency divider circuit in response to a second control signal indicating that the power supply voltage of said microcomputer is lower than said predetermined value, and
a clock generation circuit generating a system clock signal to operate said microcomputer based on an output signal from the circuit selected by said switching circuit.

2. The clock input circuit according to claim 1, further comprising a first switching element connected between an output node of said first waveform shaping circuit and an input node of said second waveform shaping circuit, rendered conductive in response to said first control signal, and rendered non-conductive in response to said second control signal.

3. The clock input circuit according to claim 2, further comprising a second switching element connected between the input node of said second waveform shaping circuit and a line of said reference potential, and rendered non-conductive in response to said first control signal, and rendered conductive in response to said second control signal.

4. The clock input circuit according to claim 1, wherein said frequency divider circuit is rendered inactive in response to said first control signal, and rendered active in response to said second control signal.

5. The clock input circuit according to claim 1, further comprising a gate circuit provided between an output node of said first waveform shaping circuit and an input node of said frequency divider circuit, blocking out a clock signal from said first waveform shaping circuit in response to said first control signal, and transmitting the clock signal from said first waveform shaping circuit to said frequency divider circuit in response to said second control signal.

6. A clock input circuit of a microcomputer, comprising:
a first waveform shaping circuit receiving an externally applied reference clock signal,
a first capacitor receiving a clock signal from said first waveform shaping circuit at one electrode, and receiving a reference potential at its other electrode,
a second capacitor receiving said reference potential at one electrode,
a switching element connecting an output node of said first waveform shaping circuit with an other electrode of said second capacitor in response to a first control signal indicating that a power supply voltage of said microcomputer is higher than a predetermined value, and disconnecting the output node of said first waveform shaping circuit from the other electrode of said second capacitor in response to a second control signal indicating that the power supply voltage of said microcomputer is lower than said predetermined value,
a second waveform shaping circuit shaping a waveform of a clock signal appearing at one electrode of said first capacitor, and
a clock generation circuit generating a system clock signal to operate said microcomputer based on an output signal from said second waveform shaping circuit.

7. The clock input circuit according to claim 1, wherein said clock generation circuit further generates a clock signal to operate a peripheral circuit.

8. The clock input circuit according to claim 1, wherein said first and second waveform shaping circuits include a Schmitt trigger circuit.

9. The clock input circuit according to claim 1, further comprising a programmable register providing said first and second control signals based on set data.

10. The clock input circuit according to claim 1, further comprising a voltage detection circuit detecting a power supply voltage of said microcomputer to output said first and second control signals based on a detection result.

11. The clock input circuit according to claim 1, wherein said first control signal includes a first wait signal indicating an operation status of said microcomputer, and said second control signal includes a second wait signal indicating a standby status of said microcomputer.
